(19) United States
(12) Patent Application Publication
(10) Pub. No.: US 2025/0336096 A1
(43) Pub. Date: Oct. 30, 2025

(54) SYSTEM AND METHOD OF IMAGE COMPRESSION

(71) Applicant: HIMAX TECHNOLOGIES LIMITED, Tainan City (TW)

(72) Inventor: Po Chang CHEN, Tainan City (TW)

(21) Appl. No.: 18/981,626

(22) Filed: Dec. 15, 2024

Related U.S. Application Data
(60) Provisional application No. 63/637,900, filed on Apr. 24, 2024.

(51) Int. Cl. G06T 9/00

(52) U.S. Cl. CPC G06T 9/00

(57) ABSTRACT

An image compression system includes a memory having a frame buffer, a temporal noise reduction (TNR) circuit, a compression circuit, and a controller. The temporal noise reduction circuit is configured to receive a frame from an image sensor and blend the frame with a decompressed reference frame from the frame buffer into a temporal noise reduction frame. The compression circuit is configured to receive the temporal noise reduction frame from the TNR circuit and compress the temporal noise reduction frame into a compressed reference frame utilizing a ratio in the frame buffer, wherein the compression circuit is further configured to decompress the compressed reference frame in the frame buffer by the ratio as the decompressed reference frame. The controller is configured to adaptively increase the ratio according to a number of program(s) to ensure an adequate memory space of the memory for executing the program(s).

### RELATED APPLICATIONS

This application claims priority to U.S. Provisional Application Ser. No. 63/637,900, filed on Apr. 24, 2024, which is herein incorporated by reference.

### BACKGROUND

### Technical Field

The present disclosure relates to a compression system in a camera module, and more particular to an image compression system.

### Description of Related Art

High screen-to-body ratio has been a requirement for consumer devices such as notebooks and cellphones. Due to this requirement, camera modules of the consumer devices are requested to squeeze size, especially Y-dimension size of the camera modules, and stay low-cost meanwhile. The image sensor keeps shrunk the pixel size towards 1.12 μm or even smaller so that the image signal processor needs to take good care of sensor noises. Spatiotemporal noise reduction is an effective method to deal with high noises of the sensor and normally implemented with a temporal noise reduction (TNR) cascaded by a spatial noise reduction (2DNR).

A camera module includes an ISP for processing image such as TNR, 2DNR, black level subtraction (BLS), auto white balance (AWB), color correction, etc. A camera module may further include an artificial intelligence (AI) detection for applications of post host, thus has limited in module size and cost. It means various operations/programs share limited SRAM in series or parallel way. When two or more high need programs are parallel executed and DRAM is not feasible, the embedded SRAM inside the camera module is insufficient for parallel operating.

There is a need to propose a new method or system to use the limited embedded memory (SRAM) efficiently for parallel operating programs.

### SUMMARY

The object of the present disclosure is to provide an image compression system and method for parallel executing programs under the condition that the memory space of the camera module is limited.

One aspect of the present disclosure relates to an image compression system includes a memory having a frame buffer, a temporal noise reduction (TNR) circuit, a compression circuit coupled to the TNR circuit, and a controller. The temporal noise reduction circuit is configured to receive a frame from an image sensor and blend the frame with a decompressed reference frame from the frame buffer into a temporal noise reduction frame. The compression circuit is configured to receive the temporal noise reduction frame from the TNR circuit and compress the temporal noise reduction frame into a compressed reference frame utilizing a ratio, wherein the compressed reference frame is stored in the frame buffer, and wherein the compression circuit is further configured to decompress the compressed reference frame in the frame buffer by the ratio as the decompressed reference frame. The controller is configured to adaptively adjust the ratio if parallel executing the at least two programs.

In accordance with one or more embodiments of the present disclosure, the TNR circuit is further configured to perform weighting calculation on pixel data of the frame and pixel data of the decompressed reference frame, so as to obtain the temporal noise reduction frame.

In accordance with one or more embodiments of the present disclosure, the image compression system further comprises a spatial noise reduction (2DNR) circuit configured to receive the temporal noise reduction frame from the TNR circuit and perform weighting calculation to process the temporal noise reduction frame into a spatial noise reduction frame.

In accordance with one or more embodiments of the present disclosure, the 2DNR circuit is further configured to perform weighting calculation on pixel data and surrounding pixel data of the temporal noise reduction frame, so as to obtain the spatial noise reduction frame.

In accordance with one or more embodiments of the present disclosure, the TNR circuit is further configured to determine whether each pixel in the frame is a still pixel or a moving pixel, so as to obtain a pixel status result.

In accordance with one or more embodiments of the present disclosure, the TNR circuit and the 2DNR circuit performs weighting calculation based on the pixel status result.

In accordance with one or more embodiments of the present disclosure, the controller utilizes a first noise reduction (NR) setting for noise reduction in response to the ratio decreasing, and wherein the controller utilizes a second NR setting for noise reduction in response to the ratio increasing, wherein the first NR setting is composed of a first TNR setting and a first 2DNR setting, and wherein the second NR setting is composed of a second TNR setting and a second 2DNR setting.

In accordance with one or more embodiments of the present disclosure, the controller is further configured to increase the ratio to release a part of the memory in response to the at least two programs needing to be executed.

In accordance with one or more embodiments of the present disclosure, the at least two programs includes at least one video program and at least one CV/NN program, and the controller is further configured to utilize the part of the memory to execute the at least one CV/NN program.

Another aspect of the present disclosure relates to an image compression method, which includes receiving a frame from an image sensor; blending the frame with a decompressed reference frame from a frame buffer into a temporal noise reduction frame by a TNR circuit; adjusting a ratio by a controller if parallel executing at least two programs; compressing the temporal noise reduction frame into a compressed reference frame by a compression circuit according to the ratio determined by the controller; and decompressing the compressed reference frame by the compression circuit as the decompressed reference frame according to the ratio determined by the controller, wherein the controller increases the ratio in response to the at least two programs need to be executed, wherein the controller decreases the ratio in response to the at least two programs are completed.

### BRIEF DESCRIPTION OF THE DRAWINGS

This disclosure can be more fully understood by reading the following

detailed description of the embodiments, with reference made to the accompanying drawings as follows:

FIG. 1 is a functional block diagram of an image compression system in accordance with some embodiments of the present disclosure.

FIG. 2 is a schematic diagram of parallel executing video programs and CV/NN programs in accordance with some embodiments of the present disclosure.

FIG. 3 is a flowchart of an image compression method in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts. The verb “couple” and its conjugated forms means to complete any type of required junction, including electrical, mechanical or fluid, to form a singular object from two or more previously non-joined objects.

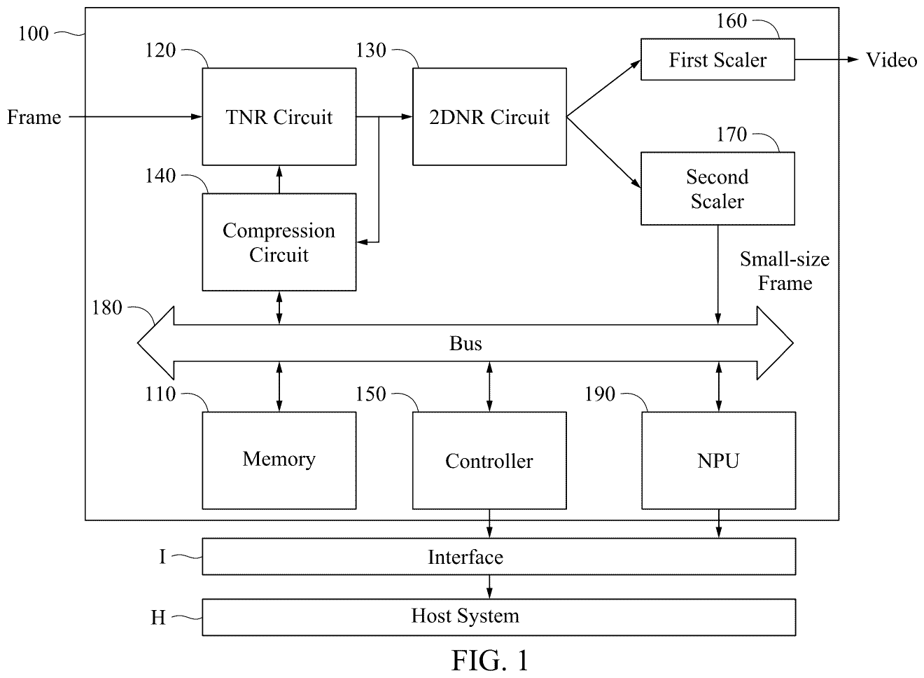

FIG. 1 is a functional block diagram of an image compression system 100 in accordance with some embodiments of the present disclosure. The image compression system 100 includes a memory 110 having a frame buffer (not shown in FIG. 1), a temporal noise reduction (TNR) circuit 120, a spatial noise reduction (2DNR) circuit 130, a compression circuit 140 coupled to the TNR circuit 120, a controller 150, a first scaler 160, a second scaler 170, a bus 180, and a neural network processing unit (NPU) 190. The memory 110 may be a random access memory (RAM), static random-access memory (SRAM), a flash memory, a solid state drive (SSD), other similar components, or a combination of the above components, but is not limited to this. The controller 150 is coupled/connected to the memory 110 and the compression circuit 140 through the bus 180, and is configured to adaptively adjust the ratio if at least two parallel programs are executed. It should be noted that the at least two programs comprises at least one video program and at least one computer vision/neural network (CV/NN) program. The controller 150 has a processor, and the processor may be a central processing unit (CPU), a graphics processing unit (GPU), a microcontroller unit (MCU), a microprocessor, a system-on-chip (SoC), a digital signal processor (DSP), an application-specific integrated circuit (ASIC), a programmable logic controller (PLC), or a combination of the above components, but not limited to this. The bus 180 may be an advanced extensible interface (AXI) bus, or an advanced high performance bus (AHB), but not limited to this. The NPU 190 is coupled to the memory 110 and the second scaler 170 through the bus 180.

The image compression system 100 in FIG. 1 is mainly applied to the image signal processor (ISP) chip, digital signal processor (DSP) chip or artificial intelligence (AI) processor chip utilized in the camera module embedded in an electronic device (such as a notebook computer). In some embodiments, the ISP chip (or DSP chip, AI processor chip) may also be utilized in an external USB web camera. It should be noted that the memory 110, the TNR circuit 120, the 2DNR circuit 130, the compression circuit 140, the controller 150, the first scaler 160, the second scaler 170, the bus 180, and the NPU 190 are within the ISP chip (or DSP chip, AI processor chip). The image compression system 100 communicates with a host system H of the electronic device through an interface I, as shown in FIG. 1.

In some embodiments, the image sensor may be a visible light sensor, a complementary metal-oxide-semiconductor (CMOS) image sensor, a charge-coupled device (CCD) image sensor, other light sensing components, other light sensing devices, or a combination of the above components, but is not limited to this. It should be noted that more than one image sensor may be disposed according to different applications.

After the frame is captured by the image sensor, the TNR circuit 120 is configured to receive the frame from the image sensor and blend the frame with a decompressed reference frame from the frame buffer into a temporal noise reduction frame.

In specific, the TNR circuit 120 is configured to blend the frame and the decompressed reference frame through a blending mean in the TNR circuit. It should be noted that the blending mean blends the frame and the decompressed reference frame by performing weighting calculation on pixel data of the frame and pixel data of the decompressed reference frame to obtain the temporal noise reduction frame.

Although TNR is an effective method to deal with high noises of the image sensor, TNR requires a considerable memory space in the memory 110 as the frame buffer for storage of the processed frame. Accordingly, to suppress the cost of the memory 110, a compression/decompression process can be utilized. In this way, the processed frame by TNR circuit 120 can be compressed to decrease the frame size and then written into a much smaller memory space.

The compression circuit 140 is coupled to the TNR circuit 120. In order to suppress the cost of the memory 110, after the TNR circuit 120 obtaining the temporal noise reduction frame, the compression circuit 140 is configured to receive the temporal noise reduction frame from the TNR circuit 120 and compress the temporal noise reduction frame into a compressed reference frame utilizing a ratio, and then write the compressed reference frame into the frame buffer. Since the compressed reference frame is of smaller size than the temporal noise reduction frame, the size of memory 110 can be reduced for decreasing the cost of the chip. In addition, the compression circuit 140 is further configured to decompress the compressed reference frame in the frame buffer by the ratio as the decompressed reference frame for a next frame later to the frame.

The TNR circuit 120 is further configured to determine whether each pixel in the frame is a still pixel or a moving pixel, so as to obtain a pixel status result. In one embodiment of the present disclosure, the pixel status result includes weightings for the still pixel and the moving pixel.

After obtaining the pixel status result, the controller 150 utilizes the TNR circuit 120 and a spatial noise reduction (2DNR) circuit 130 to process the still/moving pixel in the frame based on the pixel status result. That is, the controller 150 utilizes the TNR circuit 120 and the 2DNR circuit 130 to process the still/moving pixel in the frame based on the weightings for the still/moving pixel. In specific, the image compression system 100 further includes the 2DNR circuit 130 coupled to the TNR circuit 120, configured to receive the temporal noise reduction frame from the TNR circuit 120 and process the still/moving pixel of the temporal noise reduction frame into a spatial noise reduction frame. Further, the 2DNR circuit is configured to perform weighting calculation on central pixel data and surrounding pixel data of the still/moving pixels of the temporal noise reduction frame, so as to obtain the spatial noise reduction frame.

It should be noted that the controller 150 utilizes both of the TNR circuit 120 and the 2DNR circuit 130 to process the every pixels in the frame (including the input frame and the temporal noise reduction frame). In one embodiment of the present disclosure, because the TNR circuit 120 has a better effect on reducing the noise of still pixels, after the TNR circuit 120 determines the pixel in the frame is a still pixel, the controller 150 may increase weightings of the decompressed reference frame (meanwhile, decrease weightings of the input frame) to process the still pixel to obtain the temporal noise reduction frame.

In another embodiment of the present disclosure, because the 2DNR circuit 120 has a better effect on reducing the noise of moving pixels, after the TNR circuit 120 determines the pixel in the frame is a moving pixel, the controller 150 may increase weightings of the surrounding pixel data of the temporal noise reduction frame (meanwhile, decrease weightings of the central pixel data of the temporal noise reduction frame) to process the moving pixel to obtain the spatial noise reduction frame.

Under the condition that the memory space of the camera module is limited, the ISP chip may not have an adequate memory space to execute CV/NN programs in parallel while video output for user viewing. Accordingly, the controller 150 of the image compression system 100 is configured to adaptively adjust the ratio to ensure an adequate memory space of the memory 110 for executing the CV/NN programs in parallel while video output for user viewing. In specific, the ratio is increased to release a part of the memory 110 by the controller 150 in response to the at least two programs (e.g., at least one video program and at least one CV/NN program) need to be executed.

Since adjusting the ratio may change the resolution of the output video, in order to smooth the output video to ensure the viewing experience of the user, an appropriate noise reduction (NR) setting needs to be applied.

In one embodiment of the present disclosure, the controller 150 utilizes a first NR setting for noise reduction in response to the ratio decreasing, in which the first NR setting is composed of a first TNR setting and a first 2DNR setting. The controller 150 increases a TNR strength in response to the ratio decreasing. In specific, the TNR circuit 120 utilizes more decompressed reference frame than the input frame while blending the frame with the decompressed reference frame into the temporal noise reduction frame.

In another embodiment of the present disclosure, the controller 150 utilizes a second NR setting for noise reduction in response to the ratio increasing, in which the second NR setting is composed of a second TNR setting and a second 2DNR setting. The controller 150 increases a 2DNR strength in response to the ratio increasing. In specific, the 2DNR circuit 130 utilizes more second pixel of the temporal noise reduction frame surrounding the first pixel than the first pixel while performing the weighting calculation to process the temporal noise reduction frame into the spatial noise reduction frame.

It should be noted that in the above two embodiments, the TNR strength of the first TNR setting is stronger than the TNR strength of the second TNR setting, and the 2DNR strength of the first 2DNR setting is weaker than the 2DNR strength of the second 2DNR setting.

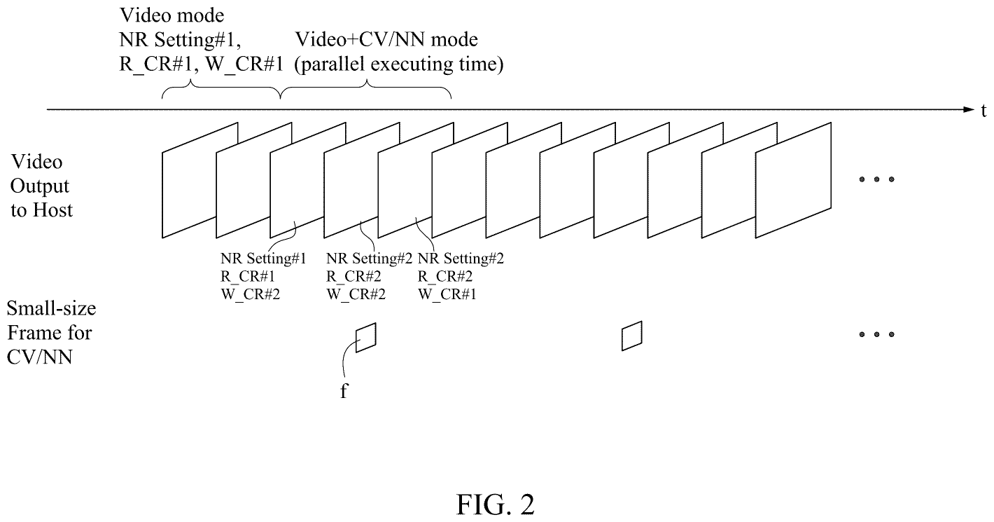

The operation mode of the image compression system 100 applied in an ISP chip may be divided into two modes: a video mode and a Video+CV/NN mode. FIG. 2 is a schematic diagram of parallel executing video programs and CV/NN programs in accordance with some embodiments of the present disclosure. The present disclosure proposes a dynamic ratio image compression method utilizing TNR. While the image compression system 100 is in the video mode, only video programs are executed. While video programs and CV/NN programs need to be executed at the same time, the image compression system 100 is switched from the video mode to the Video+CV/NN mode (also referred to as Video+CV mode in FIG. 2), and the ratio may be increased by the controller 150 to free up part of the memory space for parallel executing CV/NN programs. It should be noted that the process of capturing frames from the image sensor and outputting the video to the host system (such as host system H shown in FIG. 1) is still continuing while the image compression system 100 is in the Video+CV/NN mode. After the CV/NN programs completed, the controller 150 decreases the ratio to allow the TNR circuit 120 to utilize a larger memory space, and the quality of the output video may return to normal.

It should be noted that the image compression system 100 switches to the Video+CV/NN mode intermittently rather than being continuously in the Video+CV/NN mode. Accordingly, the compression ratio is increased/decreased in response to the intermittent execution of CV/NN programs.

It should be noted that switch operations between the video mode and the Video+CV/NN mode of the image compression system 100 are progressive. In one embodiment of the present disclosure, referring to the first two frame in FIG. 2, in the video mode, the compression ratio (expressed as W_CR#1 in FIG. 2) and the decompression ratio (expressed as R_CR#1 in FIG. 2) of the first NR setting (expressed as NR_Setting#1 in FIG. 2) are 3.33, for example. Then referring to the third frame in FIG. 2, the compression ratio is increased from 3.33 to 5 (W_CR#2 is 5, for example) by the controller 150 while the image compression system 100 switches from the video mode to the Video+CV/NN mode (expressed as Video+CV mode in FIG. 2). Then referring to the fourth frame in FIG. 2, the decompression ratio is also increased from 3.33 to 5 (R_CR#2 is 5, for example) with a part of memory 110 released for storing a small-size frame f to execute CV/NN programs. Meanwhile, the first NR setting is changed to the second NR setting (expressed as NR_Setting#2 in FIG. 2) by the controller 150 in response to the ratio increasing, that is, the controller 150 utilizes the second NR setting for noise reduction of the frame of the output video. Then referring to the fifth frame in FIG. 2, the compression ratio is decreased from 5 to 3.33 by the controller 150 after the CV/NN programs completed. Then referring to the sixth frame in FIG. 2, the decompression ratio is also decreased from 5 to 3.33 by the controller 150. Meanwhile, the second NR setting is changed back to the first NR setting by the controller 150 in response to the ratio increasing, that is, the controller 150 utilizes the first NR setting again for noise reduction of the frame of the output video. It should be noted that switch operations between the video mode and the Video+CV/NN mode of frames behind the seventh frame in FIG. 2 may refer to the switch operations from the first frame to the sixth frame.

The image compression system 100 further comprises the first scaler 160 and the second scaler 170, both coupled to the 2DNR circuit 130. The first scaler 160 is configured to adjust the resolution of the video output to the host system H. In one embodiment of the present disclosure, an user may set the needed resolution (such as 5Mp, 1080p, 720p, and so on) in the host system H of a camera application (APP), and the first scaler 160 of the image compression system 100 in a camera module then correspondingly adjusts the resolution of the video output to the host system H. In addition, the second scaler 170 is configured to output the small-size frame f shown in FIG. 2 for executing CV/NN programs. It should be noted that the video output through the first scaler 160 for user viewing is still on-going in parallel when the small-size frame f for CV/NN programs output through the second scaler 170.

After adaptively adjusting the ratio for compressing/decompressing, the controller 150 then utilizes the released part of the memory 110 to execute the CV/NN programs. In one embodiment of the present disclosure, the controller 150 notifies the NPU 190 to receive the small-size frame f from the second scaler 170 through the bus 180, and execute the needed CV/NN programs. In another embodiment of the present disclosure, the second scaler 170 first stores the small-size frame f into the memory 110, and the NPU 190 then access the small-size frame f stored in the memory 110 to execute CV/NN programs. After each of the CV/NN programs is completed by the NPU 190, the controller 150 is further configured to decrease the ratio, and the image compression system 100 switches from the Video+CV/NN mode into the video mode.

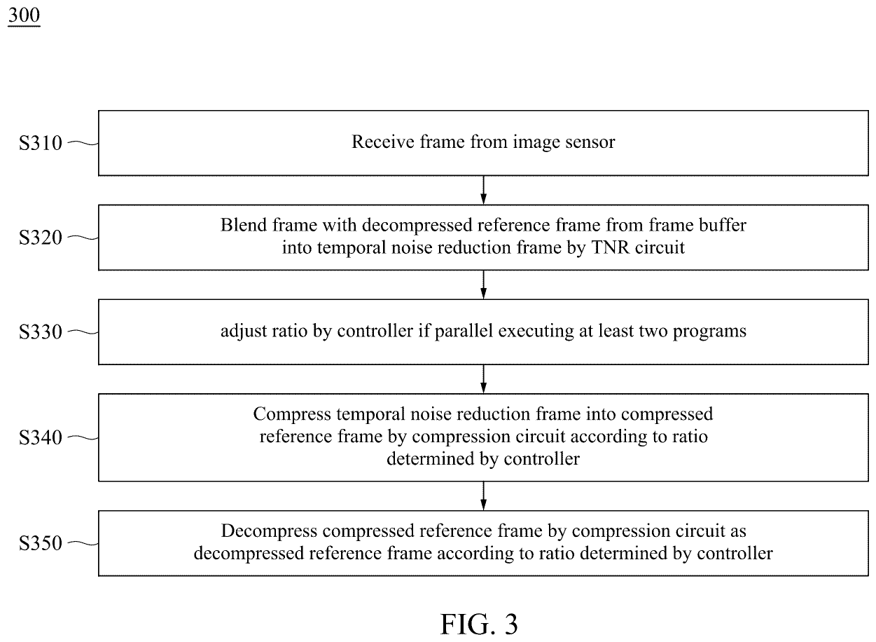

FIG. 3 is a flowchart of an image compression method 300 in accordance with some embodiments of the present disclosure. The image compression method 300 may be utilized for a system including a memory, a TNR circuit, a 2DNR circuit, a compression circuit, a controller, a first scaler, a second scaler, a bus, and a NPU shown in FIG. 1 (such as image compression system 100 shown in FIG. 1) or other similar systems. As shown in FIG. 3, the image compression method 300 includes steps S310 to S350. The following paragraphs describe the implementation method of each step in conjunction with FIGS. 1-3.

Step S310: receive frame from image sensor and store frame in frame buffer of memory. The description of Step S310 may refer to the operation of each component in the image compression system 100 shown in FIG. 1, for example, and will not be described again here.

Step S320: blend frame with decompressed reference frame from frame buffer into temporal noise reduction frame by TNR circuit. The description of Step S320 may refer to the operation of each component in the image compression system 100 shown in FIG. 1, for example, and will not be described again here.

Step S330: determine ratio by controller according to number of program needs to be executed. The description of Step S330 may refer to the operation of each component in the image compression system 100 shown in FIG. 1, for example, and will not be described again here.

Step S340: compress temporal noise reduction frame into compressed reference frame by compression circuit according to ratio determined by controller. The description of Step S340 may refer to the operation of each component in the image compression system 100 shown in FIG. 1, for example, and will not be described again here.

Step S350: decompress compressed reference frame by compression circuit as decompressed reference frame according to ratio determined by controller. The description of Step S350 may refer to the operation of each component in the image compression system 100 shown in FIG. 1, for example, and will not be described again here.

As can be seen from the above description, the image compression system and method provides parallel execution of programs (such as video programs and CV/NN programs) under the condition that the memory space of the camera module is limited, and utilizes an appropriate NR setting for noise reduction in response to the compression ratio increasing/decreasing, so as to ensure the viewing experience of the user.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. An image compression system, comprising:
a memory having a frame buffer;
a temporal noise reduction (TNR) circuit configured to receive a frame from an image sensor and blend the frame with a decompressed reference frame from the frame buffer into a temporal noise reduction frame;
a compression circuit coupled to the TNR circuit, configured to receive the temporal noise reduction frame from the TNR circuit and compress the temporal noise reduction frame into a compressed reference frame utilizing a ratio, wherein the compressed reference frame is stored in the frame buffer, and wherein the compression circuit is further configured to decompress the compressed reference frame in the frame buffer by the ratio as the decompressed reference frame; and
a controller configured to adaptively adjust the ratio if parallel executing at least two programs.

2. The image compression system of claim 1, wherein the TNR circuit is further configured to perform weighting calculation on pixel data of the frame and pixel data of the decompressed reference frame, so as to obtain the temporal noise reduction frame.

3. The image compression system of claim 2, wherein the image compression system further comprises a spatial noise reduction (2DNR) circuit configured to receive the temporal noise reduction frame from the TNR circuit and perform weighting calculation to process the temporal noise reduction frame into a spatial noise reduction frame.

4. The image compression system of claim 3, wherein the 2DNR circuit is further configured to perform weighting calculation on pixel data and surrounding pixel data of the temporal noise reduction frame, so as to obtain the spatial noise reduction frame.

5. The image compression system of claim 4, wherein the TNR circuit is further configured to determine whether each pixel in the frame is a still pixel or a moving pixel, so as to obtain a pixel status result.

6. The image compression system of claim 5, wherein each of the TNR circuit and the 2DNR circuit performs weighting calculation based on the pixel status result.

7. The image compression system of claim 6, wherein the controller utilizes a first noise reduction (NR) setting for noise reduction in response to the ratio decreasing, and wherein the controller utilizes a second NR setting for noise reduction in response to the ratio increasing,
wherein the first NR setting is composed of a first TNR setting and a first 2DNR setting, and
wherein the second NR setting is composed of a second TNR setting and a second 2DNR setting.

8. The image compression system of claim 1, wherein the controller is further configured to increase the ratio to release a part of the memory in response to the at least two programs needing to be executed.

9. The image compression system of claim 8, wherein the at least two programs comprises at least one video program and at least one computer vision/neural network (CV/NN) program, and wherein the controller is further configured to utilize the part of the memory to execute the at least one CV/NN program.

10. An image compression method, comprising:
receiving a frame from an image sensor;
blending the frame with a decompressed reference frame from a frame buffer into a temporal noise reduction frame by a TNR circuit;
adjusting a ratio by a controller if parallel executing at least two programs;
compressing the temporal noise reduction frame into a compressed reference frame by a compression circuit according to the ratio determined by the controller; and
decompressing the compressed reference frame by the compression circuit as the decompressed reference frame according to the ratio determined by the controller,
wherein the controller increases the ratio in response to the at least two programs need to be executed,
wherein the controller decreases the ratio in response to the at least two programs are completed.

11. The image compression method of claim 10, wherein the TNR circuit is further configured to perform weighting calculation on pixel data of the frame and pixel data of the decompressed reference frame, so as to obtain the temporal noise reduction frame.

12. The image compression method of claim 11, wherein the image compression method further comprises receiving the temporal noise reduction frame from the TNR circuit and performing weighting calculation to process the temporal noise reduction frame into a spatial noise reduction frame by a 2DNR circuit.

13. The image compression method of claim 12, wherein the 2DNR circuit is further configured to perform weighting calculation on pixel data and surrounding pixel data of the temporal noise reduction frame, so as to obtain the spatial noise reduction frame.

14. The image compression method of claim 13, wherein the TNR circuit is further configured to determine whether each pixel in the frame is a still pixel or a moving pixel, so as to obtain a pixel status result.

15. The image compression method of claim 14, wherein the each of the TNR circuit and the 2DNR circuit performs weighting calculation based on the pixel status result.

16. The image compression method of claim 15, wherein the controller utilizes a first noise reduction (NR) setting for noise reduction in response to the ratio decreasing, and wherein the controller utilizes a second NR setting for noise reduction in response to the ratio increasing,
wherein the first NR setting is composed of a first TNR setting and a first 2DNR setting, and
wherein the second NR setting is composed of a second TNR setting and a second 2DNR setting.

17. The image compression method of claim 10, wherein the ratio is increased to release a part of a memory by the controller in response to the at least two programs needing to be executed.

18. The image compression method of claim 17, wherein the at least two programs comprises at least one video program and at least one CV/NN program, and wherein the part of the memory is utilized to execute the at least one CV/NN program by the controller.
